(19) United States
(12) Patent Application Publication
(10) Pub. No.: US 2016/0268688 A1
(43) Pub. Date: Sep. 15, 2016

(54) LOOP ANTENNA FIXTURES AND METHODS

(71) Applicant: Gatekeeper Systems, Inc., Irvine, CA (US)

(72) Inventors: John C. McKay, Placentia, CA (US); Jesse M. James, Santa Ana, CA (US); Stephen E. Hannah, Placentia, CA (US)

(21) Appl. No.: 15/160,289

(22) Filed: May 20, 2016

Related U.S. Application Data
(63) Continuation of application No. PCT/US2014/067455, filed on Nov. 25, 2014.
(60) Provisional application No. 61/909,628, filed on Nov. 27, 2013.

(51) Int. Cl. H01Q 7/00; H01Q 1/14; H01Q 1/42

(52) U.S. Cl. CPC H01Q 7/00; H01Q 1/42; H01Q 1/14

(57) ABSTRACT

Various loop antenna fixture embodiments are disclosed. The fixture can be configured to removably attach with other fixtures, thus changing the overall dimensions of an antenna wrapped around the periphery of the fixture or fixtures. Advantageously, after the antenna is wrapped around the fixture(s) to form an assembly, the entire assembly can be removed and installed without the requirement of removing the antenna from the fixture(s).

### CROSS-REFERENCE TO RELATED APPLICATIONS

This application claims the benefit under 35 U.S.C. §120 and 35 U.S.C. §365(c) as a continuation of International Application No. PCT/US2014/067455, designating the United States, with an international filing date of Nov. 25, 2014, which claims the priority benefit under 35 U.S.C. §119(e) of U.S. Provisional Application No. 61/909,628, filed Nov. 27, 2013. The entirety of each of the aforementioned applications is hereby incorporated by reference. Further, all applications for which a foreign or domestic priority claim is identified in the Application Data Sheet as filed with the present application are hereby incorporated by reference.

### BACKGROUND

1. Field

The disclosure relates to embodiments of loop antennas and manufacturing fixtures, as well as to the manufacturing and installation of loop antennas and fixtures.

2. Description of Certain Related Art

Loop antennas are antennas typically used for transmission of radio waves. Typical loop antennas consist of one or more loops of wire, tubing, or other electrical conductors with connected ends, thus forming a loop. Loop antennas can be used to send or receive electromagnetic signals for a variety of purposes.

### SUMMARY

Various embodiments of a removable antenna fixture for assembly of an antenna are disclosed. In some embodiments, the antenna fixture includes a platform (e.g., a base) having a first end and a second end (and can include a width and thickness). The first and second ends can be located generally opposite from one another, such as at a first longitudinal end and a second longitudinal end. The fixture can include a plurality of legs (e.g., projections, ribs, or other extending members). The legs can be positioned (e.g., extend around) the periphery of the platform, either generally equidistantly spaced or non-equidistantly spaced from each other. Some or each of the plurality of legs can have an antenna retainer portion (such as a slot, groove, indentation, or otherwise). A wire can be positioned in the retainer portions of the legs. For example, the wire can be wrapped around periphery of the platform and/or retained within the antenna retainer portion of some or each of the plurality of legs. In some embodiments, the wrapped wire thereby forms a loop antenna. Certain implementations include a first attachment element, such as a male portion. The first attachment element can be located on the first end of the platform and can have a first attachment configuration. Some implementations include a second attachment element, such as a female portion. The second attachment element can be located on the second end of the platform and can have a second attachment configuration. In various embodiments, the first attachment configuration of the first attachment element is configured to mate with (e.g., engage with, interface with, be secured with, etc.) the second attachment configuration of the second attachment element of another instance of the antenna fixture.

The platform can include securing feature, such as a threaded aperture (e.g., hole, passageway, insert). The aperture can pass at least partially through a thickness of the platform (or fully through the thickness). The threaded aperture can be configured receive and retain a screw (or other attachment means such as a nail or tie). Therefore, the platform can be removably attached to a surface (e.g., floor, bench, second platform). The platform can include a score line (broken or unbroken) configured to reduce the size of the removable fixture upon breaking, such as by snapping or cutting the platform at the score line.

In some embodiments, the removable fixture can include a plurality of legs (e.g., projections, ribs, or other extending members), such as a plurality of pairs of legs. The legs in each pair can be located on opposite sides of a width of the platform from one another (or generally opposite). In some embodiments, the removable antenna fixture can include cross support structures (or struts). These cross support structure can connect pairs (or more) of legs. In some embodiments, the removable antenna fixture can include axial support structures (or struts). The axial support struts can connect adjacent cross support structures or just provide structural support. In some embodiments, the removable antenna fixture can include an energy source, such as a battery or capacitor (either on the fixture or an attachment element to another energy source). The removable antenna fixture can include a transmitter (or receiver) attached to the platform.

Various embodiments of an antenna assembly can include at least two of removable fixtures, such as those described above. The first attachment element of a first fixture can be mated (or connected reversibly or otherwise) with the second attachment element of a second fixture (and the second can be attached to a third and so on). In some embodiments, each of the fixtures is identical (or generally identical). In some embodiments, the antenna assembly can include a housing (e.g., container or casing). The housing can be configured to slidably receive the fixtures.

Also disclosed herein are embodiments of a method of manufacturing a loop antenna. The method can include providing a fixture can include a platform having a first end and a second end, such as those described above. The first and second ends can be located generally opposite of one another, such as at a longitudinal first end and a longitudinal second end. The fixture can include plurality of retainers (e.g., legs, projections, ribs, or other extending members). The retainers can be positioned (e.g., extend around) around a periphery of the platform, either generally equidistantly spaced or non-equidistantly spaced from each other. The method can include securing the fixture to a base (e.g., surface, floor, bench). Conducting element, such as wire, can be wrapped (e.g., encircled, strung, cinched) around the retainers of the fixture to form a loop (e.g., a connected shape such as a square or circle). The loop and fixture together can form an antenna assembly. The assembly can be inserted into a housing. The fixture can be removed (e.g., unfastened, released, pulled off) from the base without removing the loop from the retainers of the fixture, so that the loop is not removed from the retainers after wrapping throughout the manufacturing and installation of the antenna fixture.

In various implementations, the fixture can be a first fixture can be attached to a second fixture. For example, the second fixture can include a platform having a first end and a second end, similar to the first fixture. The first and second ends can be located generally opposite of one another, such as at a longitudinal first end and a longitudinal second end. The second fixture can have a plurality of retainers (e.g., legs, projections, ribs, or other extending members) positioned around a periphery of the platform of the second fixture. The first and second platforms can be reversibly attached. Additional fixtures can be added as well.

In some embodiments, the first and second fixtures can be attached prior to securing the first fixture to the base. In some embodiments, the first fixture can be secured to the base before attaching the first and second fixtures.

In some embodiments, the method can include wrapping a second wire (e.g., conducting member) around the second fixture. Therefore, two loops of wires can be formed, one on the first fixture and one on the second fixture. The wire can be wrapped around the retainers of both the first and second fixtures (or more fixtures if more are used. Therefore, one loop encompassing both the first and second fixtures can be formed. In some embodiments, the method can further include installing the antenna assembly.

In some embodiments, the antenna assembly can be configured to be installed in an overhead location (e.g., ceiling, door jam, or roof). Further, transmitter (or receiver) can be located on the fixture. It can be connected to a power source (e.g., battery, capacitor). The transmitter can facilitate the transmission of a signal from the transmitter via the antenna assembly to produce a signal zone (e.g., area). This signal can be directed to a location, such as on a floor region below the overhead location.

### BRIEF DESCRIPTION OF THE DRAWINGS

FIG. 1 shows a top perspective view of an embodiment of an antenna fixture.

FIG. 2 shows a bottom perspective view of an embodiment of the antenna fixture shown in FIG. 1.

FIGS. 3A and 3B show a bottom view of another embodiment of an antenna fixture with and without electronic components.

FIG. 4 shows a perspective view of certain embodiments of retainers that can be included in any embodiment of the antenna fixture.

FIG. 5 shows a side view of the retainer of FIG. 4.

FIGS. 6A and 6B show partial perspective and end views of an antenna retained within retainers in an embodiment of an antenna fixture.

FIG. 7 shows a partial perspective view of a female connector of an embodiment of an antenna fixture.

FIG. 8 shows a partial perspective view of a male connector of an embodiment of an antenna fixture.

FIG. 9A shows a top perspective view of the connectors of FIGS. 7 and 8 in a disconnected state.

FIG. 9B and 9C show bottom and top perspective views of the connectors of FIGS. 7 and 8 in a connected state, which can facilitate a connection between two antenna fixtures.

FIGS. 10A-10C show top views of certain embodiments of an antenna fixture assembly with and without a loop antenna.

FIG. 11 illustrates a partial perspective view of an embodiment of an antenna assembly being inserted into a housing to form a housing unit assembly.

FIG. 12 illustrates an end view of the antenna assembly and housing of FIG. 11.

FIG. 13 illustrates an exploded perspective view of an enclosure cap and mounting bracket that can be used with the housing of FIG. 11.

FIG. 14 illustrates a perspective view of the enclosure cap of FIG. 13.

FIGS. 15A-15C illustrate perspective views of the mounting bracket of FIG. 13.

FIG. 16 illustrates a perspective view of the housing unit assembly of FIG. 11.

FIG. 17 illustrates an embodiment of a method of manufacturing an antenna assembly.

FIG. 18 illustrates example signal planes for an embodiment of the antenna assembly of FIG. 10C.

### DETAILED DESCRIPTION OF CERTAIN EMBODIMENTS

Various loop antenna fixtures and loop antenna fixture assemblies as well as methods of fabricating and/or positioning loop antenna fixtures and/or loop antenna fixture assemblies are described below to illustrate various examples that may be employed to achieve one or more desired improvements. In some embodiments, the devices and methods disclosed can facilitate forming, supporting, installing, and/or using a loop antenna and fixture combination. The loop antenna can have varying inductance, length, diameter, and specific width by use of a fabrication component, which can serve as both the method of constructing the antenna loop and positioning the antenna so as to broadcast a signal of defined field strength and size. Also disclosed are embodiments of a method of attaching a transmitter to the fixture for providing a mode of connection between the transmitter and the antenna.

The disclosed embodiments are only illustrative and are not intended to restrict the general disclosure presented and the various aspects and features of this disclosure. The general principles described herein may be applied to embodiments and applications other than those discussed herein without departing from the spirit and scope of the disclosure. Indeed, this disclosure is not limited to the particular embodiments shown, but is instead to be accorded the widest scope consistent with the principles and features that are disclosed or suggested herein.

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable.

### Overview

Loop antennas are generally a wire, tubing, or other electrical conductor, or a series of wire, tubing, or other electrical conductors, wrapped to form a loop. This loop can be, for example, generally circular, oval, square, or rectangular. The loop antenna can be used to transmit or receive an electromagnetic signal to, for example, prevent theft of items that would register with the signal.

Some loop antennas are formed using a permanent manufacturing fixture. This fixture is non-removably installed in a factory floor for the creation of loop antennas. Wires are wrapped around the permanent fixture in order to form wire bundles, and finally loop antennas. Once the antenna is manufactured on the fixtures, the antennas are then removed from the fixture. After removal, more wires can be wrapped around the permanent fixture to form another antenna, and this process can continue to form further antennas.

The removed loop antennas can be attached to a mounting for installation at a desired location. This can be done after removal of the antenna from the permanent fixture by the manufacturer, or the antenna and mounting can be shipped separately to an end user who can combine the two in a desired location. This can include combining the loop antenna formed with some sort of mounting base after the initial antenna manufacturing. This secondary mounting can lead to the antenna creating uneven or imperfect signal during installation, as the antenna can be damaged or moved out of position during the mounting.

As described in more detail below, in some embodiments, a loop antenna fixture 100 can be configured to be formed (e.g., wrapped) and installed (e.g., in a doorway) on the same fixture. Advantageously, this can minimize the steps for manufacturing and packaging, thus increasing the ease of manufacturing. Further, an end user would not be required to install the antenna loop onto the fixture, allowing for easier installation. Moreover, moving the fixture with the antenna loop can help to retain the antenna loop in the desired position so that the interference or low quality signal can be minimized

### Antenna Fixture

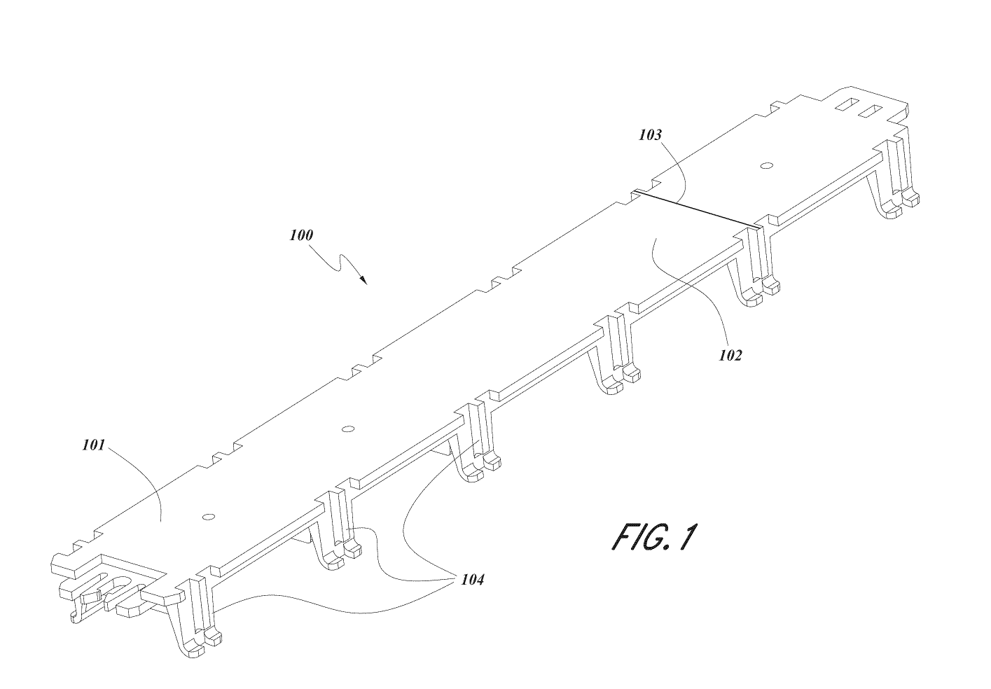

FIG. 1 illustrates a top view of an embodiment of an antenna support fixture 100. As shown, the fixture 100 can be generally sized and shaped according to the desired size and shape of the loop antenna. The loop antenna, and thus the fixture, can be generally shaped like a rectangle, square, circle, or triangle, though other shapes can be used as well. The fixture 100 can be injection molded, though other manufacturing processes can be used as well.

In some embodiments, the fixture 100 can include a platform 102 (e.g., a base). The platform 102 can include a plurality of retainers 104, which can extend from the platform 102. In some embodiments, the retainers 104 can be located along the periphery of the platform 102, such as being generally equally spaced around the periphery. As shown, the top side 101 of the platform 102 can be generally flat. However, the top side 101 of the platform 102 can contain ridges or rough surfaces that can allow for a user to more easily grip the platform 102 during movement. As mentioned above, in some embodiments, the platform 102 can be generally rectangular, as shown in FIG. 1, though the shape of the platform 102 is not limiting. In some embodiments, the retainers 104 can form a different shape than that of the platform 102.

The retainers 104 can be configured to receive and retain a portion of a loop antenna. In some embodiments, the retainers 104 can extend away from and/or in a direction generally opposite of the top side 101. In some embodiments, the retainers 104 can extend away from the platform 102 parallel to the plane of the top side 101. In some embodiments, the retainers 104 can extend partially downwards and partially in the plane of the top side 101. The direction of extension of the retainers 104 is not limiting.

In some embodiments, the fixture 100 can have 2, 3, 4, 5 or 6 retainers on each side of the platform 102. In some embodiments, the fixture 100 can have greater than 2, 3, 4, 5 or 6 retainers on each side of the platform 102. In some embodiments, the fixture 100 can have less than 2, 3, 4, 5 or 6 retainers on each side of the platform 102. In some embodiments, different sides of the platform 102 can have different numbers of retainers 104. In some embodiments, different sides of the platform 102 can have the same number of retainers 104. In some embodiments, when the platform 102 contains sides of different lengths, the amount of retainers 104 on the sides having a longer length can be different than the amount of retainers 104 on the sides having a shorter length. Further discussion of the retainers 104 can be found below.

Various sizes of the fixture 100 can be used. For example, in some embodiments, the fixture 100 has a length of at least about: 8 inches, 10 inches, 12 inches, 15 inches, 24 inches, values between the aforementioned values, and other values. In some implementations, the fixture 100 is sized to fit in a doorway, such as between the jambs and/or adjacent the header.

In some embodiments, the platform 102 can have one or more frangible portions (e.g., score lines 103) that are configured to allow the platform 102 to reduce in size. This can allow for antenna configurations of various sizes, such as sizes that do not exactly match the full length of one or more of the fixture 100. For example, for a desired antenna length of 1.5 times the fixture length, a first instance of the fixture 100 plus a second instance of the fixture 100 can be connected (as discussed in more detail below), wherein the second instance of the fixture 100 can be broken at a score point at about half the length of the second instance of the fixture 100. Some implementations include 1, 2, 3, 4, 5, 6, or more frangible portions. The frangible portions can be about equidistantly spaced along the length of the fixture 100 or can be unequally spaced.

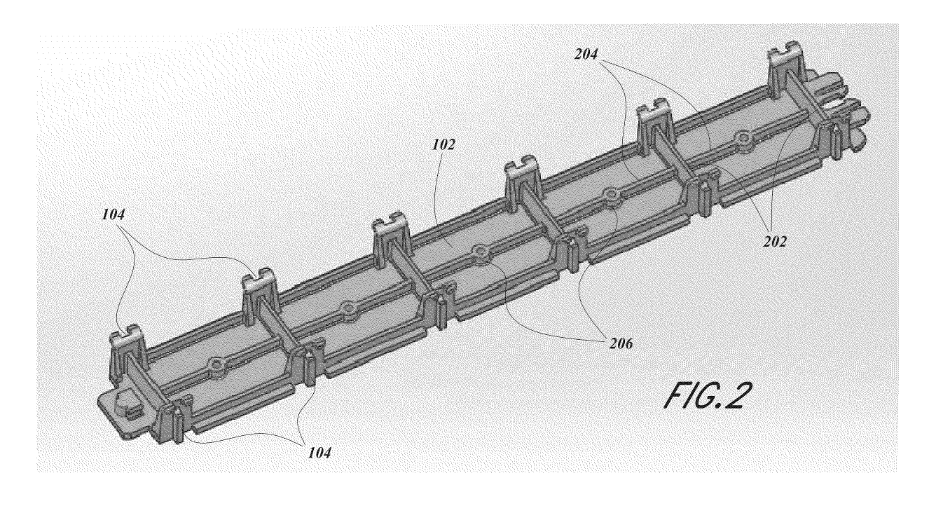

FIG. 2 illustrates an underside view of the fixture 100. As discussed, the fixture 100 can have a plurality of retainers 104 extending from the platform 102. The platform 102 can contain a plurality of cross strengthening members 202 and/or axial strengthening members 204, such as struts. However, in some embodiments, the platform 102 may not contain the strengthening members 202, 204, or may have only some of the strengthening members 202, 204 discussed below.

In some embodiments, the cross (e.g., lateral) strengthening members 202 can cross the width of the fixture 100, generally connecting pairs of retainers 104 as shown in FIG. 2. Further, the axial strengthening members 204 can extend generally parallel to the length of the fixture 100. The axial strengthening members 204 can intersect and/or connect with the cross strengthening members 202. In some embodiments, the axial strengthening members 204 can be generally centered along the width of the fixture 100. In some embodiments, a plurality of axial strengthening members 204 can be located between cross strengthening members 202, where the axial strengthening members 204 can be parallel to one another. In some embodiments, axial strengthening members 204 may not extend along the full length of the fixture 100.

In some embodiments, as is discussed in more detail below, the fixture 100 is configured to mount to a substrate (e.g., a securing surface). For example, the fixture 100 can contain apertures 206, such as in the axial strengthening members 204. In some embodiments, the apertures 206 can be threaded. The apertures 206 can be used to facilitate the fabrication process, as screws may be inserted into the apertures 206. In this embodiment, the assembly of fixture components can be secured to a work surface during the wrapping of the wire, discussed below, that forms the antenna. The apertures 206 can be aligned in a generally linear pattern along the length of the fixture 100. In some embodiments, each axial strengthening member 204 can have at least one aperture 206. In some embodiments, each axial strengthening member 204 can have more than one aperture 206. In some embodiments, each axial strengthening member 204 can have the same amount of apertures 206. In some embodiments, the axial strengthening members 204 can have a different amount of apertures 206. In some embodiments, the axial strengthening members 204 can connect axially adjacent retainers 104.

In some embodiments, the strengthening members 202, 204 can be generally the same height and thickness. In some embodiments, the strengthening members 202, 204 can have different thicknesses and/or heights. For example, the cross strengthening members 202 can be taller than the axial strengthening members 204, as shown in FIG. 2. In some embodiments, the axial and cross strengthening members 202, 204 are integrally formed with one another.

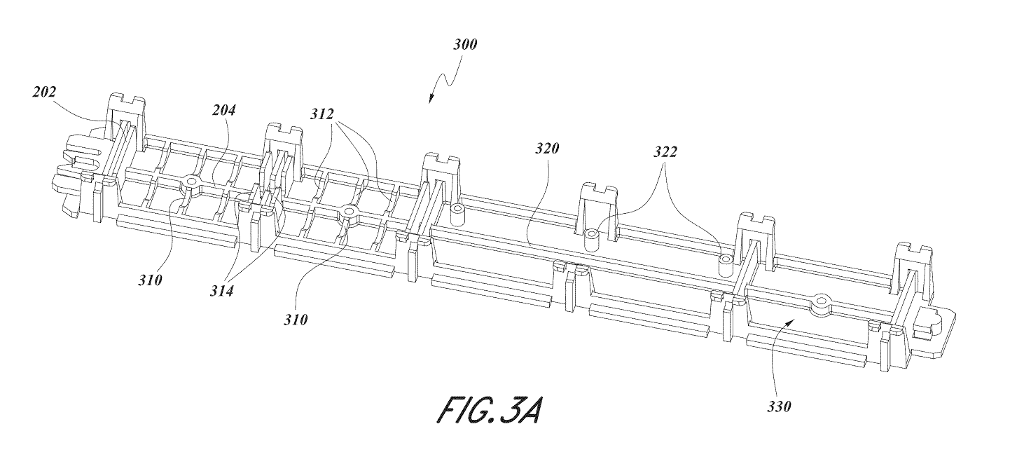

FIGS. 3A and 3B illustrate an underside view of an embodiment of a fixture 100 configured for holding electronic components. The electronic fixture 300 can be the same or identical to the fixture 100 discussed above, with certain differences discussed below. FIG. 3A shows a fixture 300 with the electronic components removed. As shown, the fixture 300 can be divided into sections. For example, the fixture 300 can include a first section (e.g., power source section 310), a second section (e.g., a transmitter section 320), and a third section (e.g., a structural section 330). While the following discussion involves this particular configuration, the fixture 300 can have only one section, or any combination of two of the sections.

As shown, the power source section 310 can contain the strengthening members 202, 204 discussed above. Further, the power source section 310 can include a plurality of support members, such as ribs 312. The ribs 312 can be sized and configured to support and/or retain a power source, such as a battery, capacitors, or a connection to external power (e.g., wiring and a plug). The power source section 310 can be configured to hold one or a plurality (e.g., 2, 3, 4, or more) of power sources, as shown in FIG. 3A. Further, the power source section 310 can include electrical contacts 314 for electrically coupling the batteries with other components, as is discussed in more detail below.

In some embodiments, the transmitter section 320 can include the strengthening members 202, 204 discussed above. The cross strengthening members 202 can be organized in order to fit a transmitter into the transmitter section 320. In certain variants, the cross strengthening members 202 can be spaced further apart than those discussed above, such as at least about 110% greater. In certain embodiments, some retainers 104 do not connect with a cross strengthening member 202. The transmitter section 320 can include apertures 322 for attachment of a transmitter to the section 320. The apertures 322 can be located on both sides, or only a single side, of the axial strengthening member 206.

In some embodiments, the strengthening section 330 can be configured (e.g., sized and shaped) like the fixture 100 discussed above with respect to FIG. 1. For example, the strengthening section 330 can include the cross and/or axial strengthening members 202, 204.

FIG. 3B shows the fixture 300 wherein batteries 316 and a transmitter 324 are installed into their respective positions. In some embodiments, the transmitter 324 can include a circuit board, a processor in communication with memory, or other electronic components. The transmitter 324 can control operational aspects of the antenna assembly, such as whether to transmit a signal via the antenna, the signal location, or the signal strength. In some embodiments, the batteries 316 are electrically coupled with the circuit board 324, such as with wires, traces, etc. In various embodiments, the batteries 316 are configured to supply electrical power to the circuit board 324.

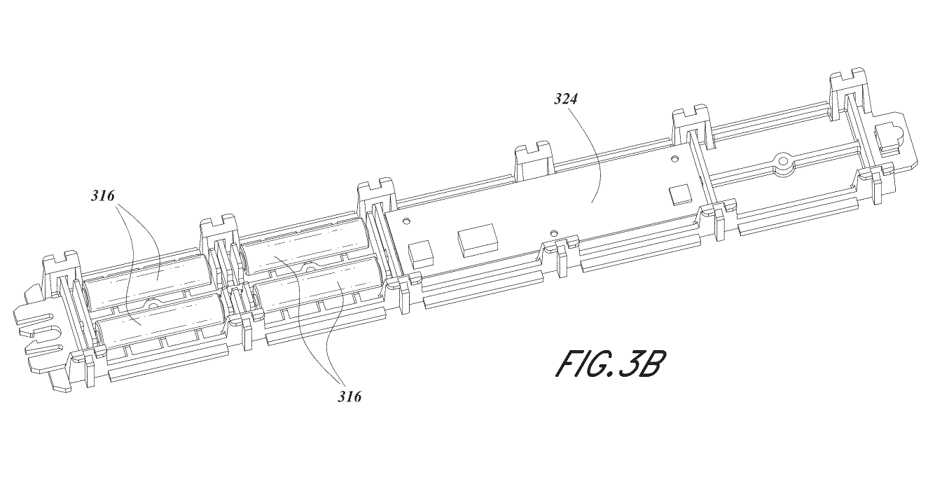

As discussed above, the fixture 100 can contain a plurality of retainers 104. FIGS. 4 and 5 illustrate different views of certain embodiments of such retainers 104. As shown in FIG. 4, each retainer can be composed of multiple (e.g., two, three, or more) retaining sections 402, which can form a retaining area 404. In some embodiments, one or more of the retaining sections 402 can be located on (e.g., at an end of) a first arm 406, and one or more of the retaining sections 402 can be located on (e.g., at an end of) the second arm 408. For example, the illustrated embodiment includes two retaining sections 402 on the first arm 406 and one retaining section 402 on the second arm 408.

As shown, the first arm 406 can extend away from platform 102. The first arm 406 can end at a curved portion, which can include the two retaining sections 402. The retaining sections 402 can be oriented outwardly and/or can extend generally away from the center of the fixture 100 in a direction generally parallel to the plane of platform 102. In some embodiments, the two retaining sections 402 can have a gap 405 located between them.

The second arm 408 can extend generally parallel to, and/or be attached to, the first arm 406. The second arm 408 can be generally laterally centered on the first arm 406 (e.g., extend along a longitudinal centerline of the first arm 406) and/or can have a thickness of approximately the same thickness of the gap 405. As noted above, the second arm 408 can include a retaining section 402, such as at an end of the second arm 408. In some variants, the retaining section 402 can have a thickness approximately the same as that of the second arm 408.

In some embodiments, the retaining area 404 can be sized and configured to accept and hold an antenna, such as a loop antenna. For example, as shown in FIG. 5, in some embodiments, the retaining area 404 can be generally shaped like a semi-circle, semi-ellipse, or otherwise rounded. In some embodiments, the upper and lower retaining sections 402 can curve towards one another at their ends. In various embodiments, the retaining area 404 forms a recess that can receive and/or secure the loop antenna. For example, the retaining section 402 can provide a physical interference that inhibits or prevents removal of the antenna from the retaining area 404. In certain embodiments, to insert or remove the antenna from the retaining area 404, the antenna must be passed over and/or outward of at least one of the retaining section 402. This can inhibit or prevent an antenna from falling out of the retaining area 404. In some embodiments, the retaining area 404 can be sized and configured to allow an antenna wire to be wrapped continuously around the fixture 100 any number of times. In some embodiments, the retaining areas 404 can aid in holding the individual wire strands together into a bundle, which can facilitate providing an antenna structure with a specific inductance.

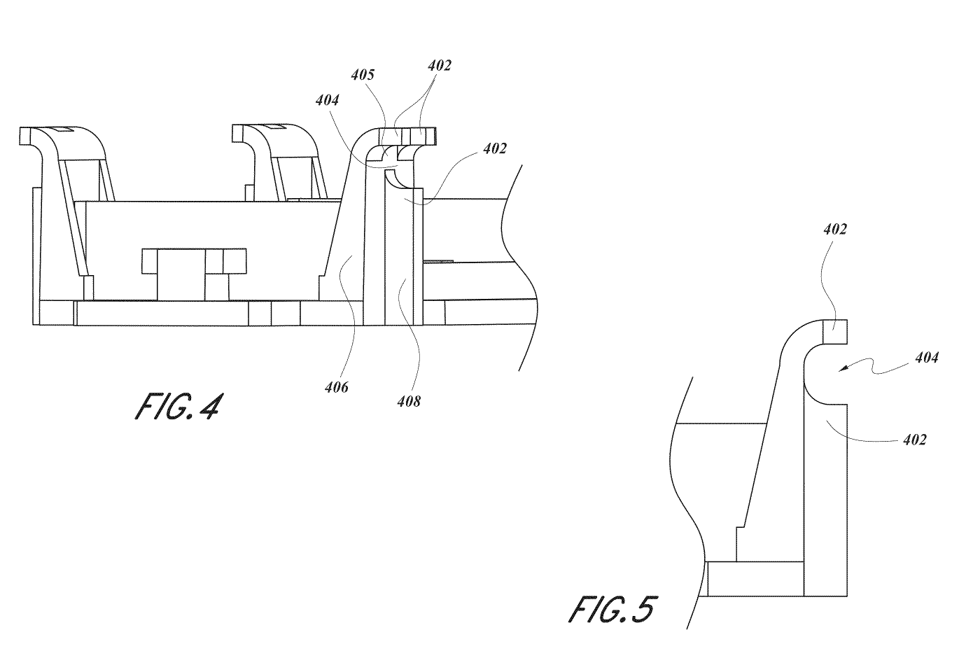

FIGS. 6A and 6B show views of the fixture 100 having an antenna 600 retained within the retaining area 404 of the retainers 402. As shown, a portion of the antenna 600 can be received in and/or at least partially surrounded by the retaining sections 402. In some embodiments, as shown in FIG. 6B, the antenna 600 can be wrapped tightly around the retainers 204 so that it remains within the retaining area 404 and/or without a majority of the retaining sections 402 touching the antenna 600. The retainers 104 can provide a way to hold the individual wire strands of the antenna 600 in the correct orientation relative to one another. In some embodiments, the retainers 104 can inhibit or prevent the movement of the antenna 600 as it is wound around the circumference of the fixture 100, discussed more in detail below.

### Mating Features and Fixture Assemblies

In some embodiments, the fixture 100 can be used alone to form an antenna. For example, the wire can be wrapped around a general periphery of the fixture 100, and/or can be received in the retainers 104. In some embodiments, multiple fixtures 100 can be attached together, such as to form fixture assemblies. This can allow the manufacturing of various antenna sizes (e.g., various lengths) using the fixture 100.

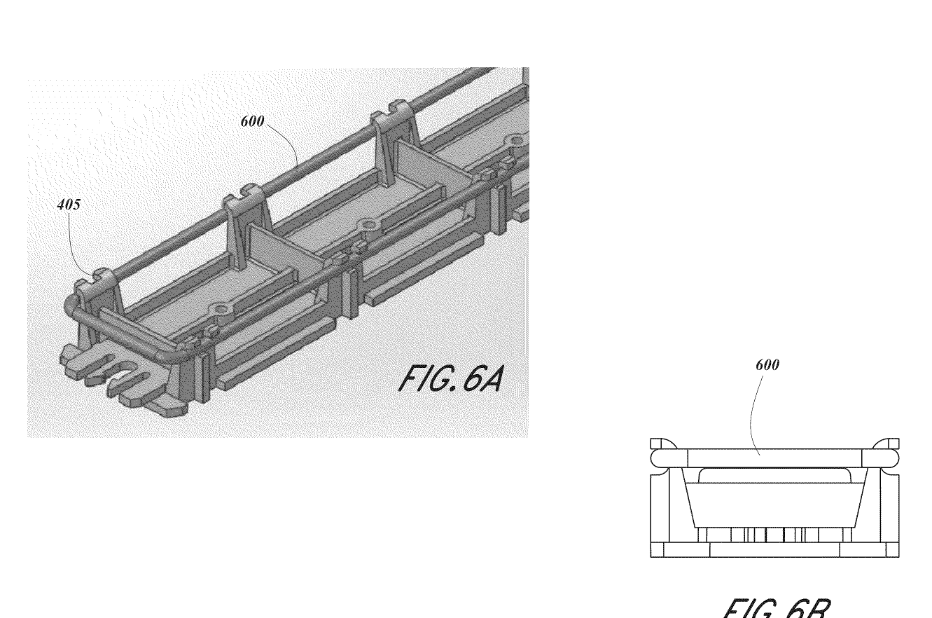

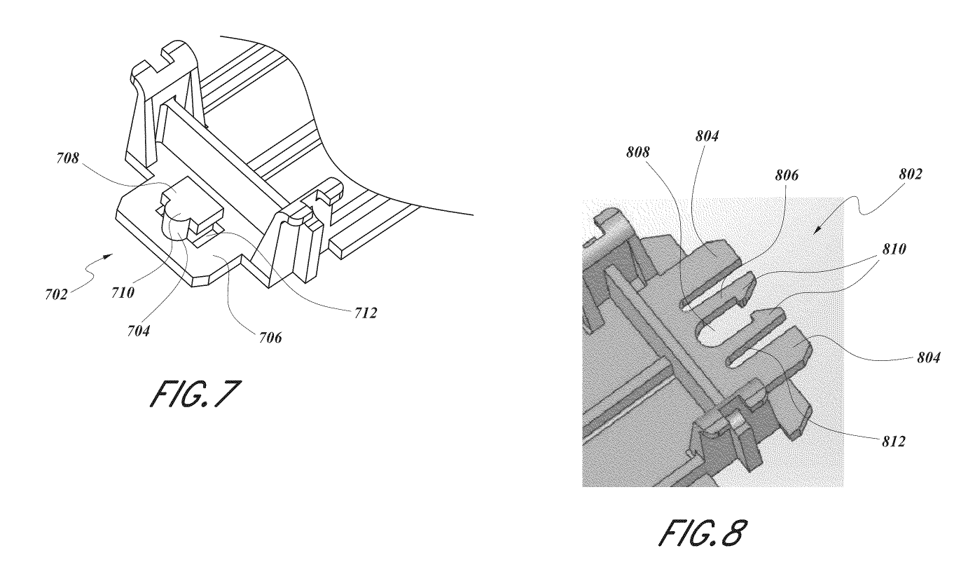

In some embodiments, first and second instances of the fixture 100 can be connected, such as in an interlocked chain. As shown in FIGS. 7-8, mating features can be used to interlock adjacent fixtures 100 together and/or can allow for the addition of successive fixture components.

In some implementations, the fixture 100 includes a first mating feature, such as a female mating portion 702, an example of which is shown in FIG. 7. As discussed in more detail below, the female mating portion 702 can matingly engage with a male mating portion 802 on another instance of the fixture 100. As shown, in some embodiments, the female mating portion 702 can be located on an end and/or on a shorter side of the fixture 100 (e.g., the shorter side of a rectangular shaped fixture 100). This can facilitate end-to-end engagement of first and second instances of the fixture 100, which can allow the formation of a fixture assembly. In some embodiments, the female mating portion 702 can be located on the longer side of a rectangular shaped fixture 100. This can facilitate side-to-side formation of a fixture assembly. In some embodiments, only one female mating portion 702 is used on a particular side. Certain variants have the female mating portion 702 generally centered on the side of the fixture. In some embodiments, multiple female mating portions 702 can be used on a particular side.

As shown in FIG. 7, the female mating 702 portion can comprise a protrusion 704. The protrusion 704 can be located on a platform extension 706, which can extend from the platform 102 of the fixture 100, such as generally longitudinally. In some embodiments, as shown, the protrusion 704 can extend in the same direction as the retainers 104. In some embodiments, the protrusion 704 can extend to less than the length of the retainers 104. In some embodiments, the protrusion 704 can extend to about half the length of the retainers 104. In some embodiments, the protrusion 704 can be rounded on one end and generally flat on another end, such as forming a norman window.

In some embodiments, a head 708 can be located on top of the protrusion 704. In some embodiments, the head 708 can have a larger footprint (e.g., surface area) than that of the protrusion 704. In some embodiments, the head 708 can be generally square in shape. In other embodiments, the shape of the head 708 is generally triangular or generally rectangular, or otherwise. In some embodiments, the head 708 includes a protrusion 710 (e.g., a generally semicircular protrusion) on at least one end.

In some embodiments, the platform extension 706 can have a plurality (e.g., two) of apertures 712. For example, the platform extension 706 can have at least one aperture 712 on either side of the protrusion 704. The apertures 712 can pass partially or completely through the platform extension 706. In some embodiments, the apertures 712 can be generally rectangular shaped. However, the shape of the apertures 712 is not limiting, and other shapes such as circles, squares, and ovals, can be used as well. In some embodiments, only one aperture 712 can be used. In some embodiments, the apertures 712 can be moved away from the protrusion 704 to a location on the platform extension 706 away from the protrusion 704.

FIG. 8 illustrates a second mating feature, such as a male mating portion 802. As mentioned above, the male mating portion 802 can connect with the female mating 702 portion of another fixture 100, thereby connecting the two fixtures 100. In some embodiments, the connected fixtures are secured, and/or are held in alignment with one another, by the interface of the male 802 and female 702 mating portions. In certain implementations, the mating engagement can inhibit or prevent the fixtures 100 from disconnecting and/or from substantially moving in a lateral or axial direction.

As shown, the male mating portion 802 can be located on the shorter side of the fixture 100. In some embodiments, the male mating portion 802 is be located on the opposite side the fixture 100 as the female mating portion 702, such as being at an opposite end of the fixture 100. This can facilitate end-to-end formation of a fixture assembly. In some embodiments, the male mating portion 802 can be located on the longer side of a rectangular shaped fixture 100, such as opposite of the female mating portion 702. This can facilitate side-to-side formation of a larger fixture assembly. In some embodiments, only one male mating portion 802 is used on a particular side. Certain variants have the male mating portion 802 generally centered on the side of the fixture. In some embodiments, both a male mating portion 802 and a female mating portion 702 can be used on the same size of the fixture 100. In some embodiments, multiple male mating portions 802 can be used on a particular side.

In some embodiments, the male mating portion 802 can be formed from a plurality (e.g., pair) of arms 804 and a plurality (e.g., pair) of locking members 806. The arms 804 and/or the locking members 806 can extend away from the platform 100. Together, the footprint of the arms 804 and locking members 806 can have generally the same footprint as the platform extension 706 of the female mating portion 702.

The arms 804 can be located on the outside of the male mating portion 802. The arms 804 can be generally rectangular in shape, wherein the ends of the arms 804 can be configured to abut the cross strengthening member 202 of the adjacent fixture 100.

The locking members 806 can be sized and configured to accept and retain the protrusion 704 of the female mating portion 702. In some embodiments, the locking members 806 form a retaining aperture 808 that is sized to retain the protrusion 704. As shown in FIG. 8, some or all of the locking members 806 can end in heads 810, which can be larger (e.g., laterally) than the locking members 806 and/or protrusion 704. In some embodiments, the locking members 806 are configured to flex outwards into gaps 812 (e.g., between the locking members 806 and/or the arms 804), which can allow the locking members 806 to engage with (e.g., generally surround) the protrusion 704. This can reduce or avoid the chance of accidental release of the protrusion 704 from the locking members 806.

In some embodiments, the locking members 806 can further comprise protrusions that can extend into the apertures 712 of the female mating portion 702, thus helping retain the two fixtures 100 in place.

In some embodiments, the fixture 100 can have one female mating portion 702 and one male mating portion 802 on opposite sides. In some embodiments, the fixture 100 can have two female 702 or male mating portions 802 on opposite sides, forming a male fixture or a female fixture.

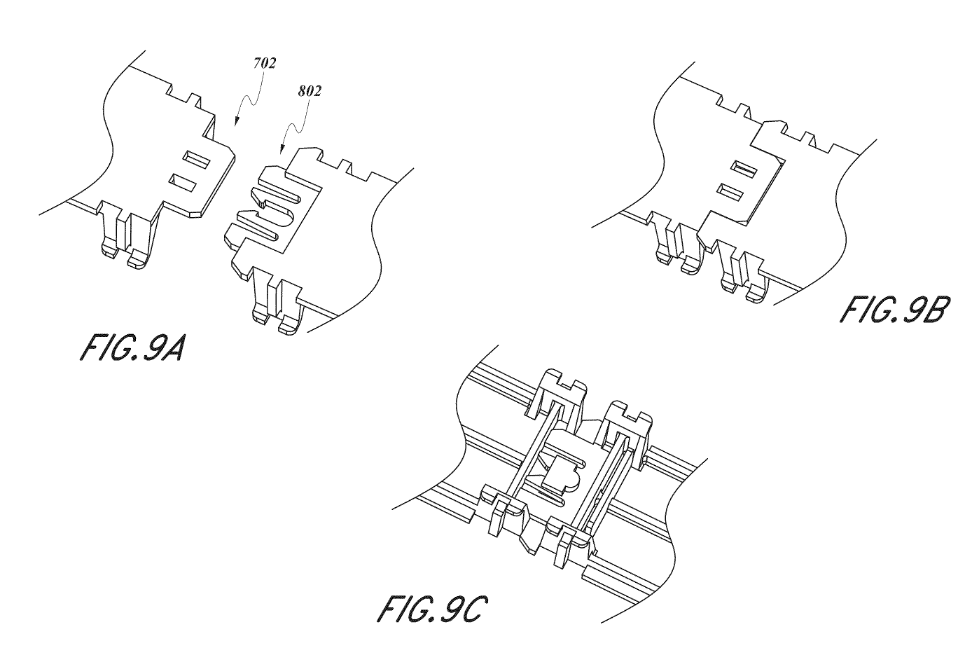

FIGS. 9A-9C illustrate an example of attaching two fixtures 100 together using the male and female mating portions 802, 702.

As shown in FIG. 9A, the male and female mating portions 802, 702 are complementary shaped. For example, the male mating portion 802 can be located slightly below the plane of the platform 102, whereas the female mating portion 702 can be located in the plane of the platform 102. Therefore, the two portions 702, 802 can overlap one another during attachment, allowing the two fixtures 100 to be adjacent to one another. In some variants, the male attachment portion 802 can include complementary arms 902, which can be sized to abut the adjacent fixture 100 while surrounding the female mating portion 702 on the same plane as the female mating portion 702.

FIGS. 9B and 9C illustrate views of the attached fixtures 100. As shown, the locking members 806 are engaged with (e.g., generally surround) and retain the protrusion 704. In certain implementations, the head 706 of the protrusion 704 can retain the locking members 806 in place. In some embodiments, the fixtures 100 can be separated through the manual spreading of the locking members 806. As shown, in some embodiments, the platform extension 706 is received in a channel in the male mating portion 802, such as on a bottom portion of the attached fixtures 100.

### Antenna Fixture Assemblies

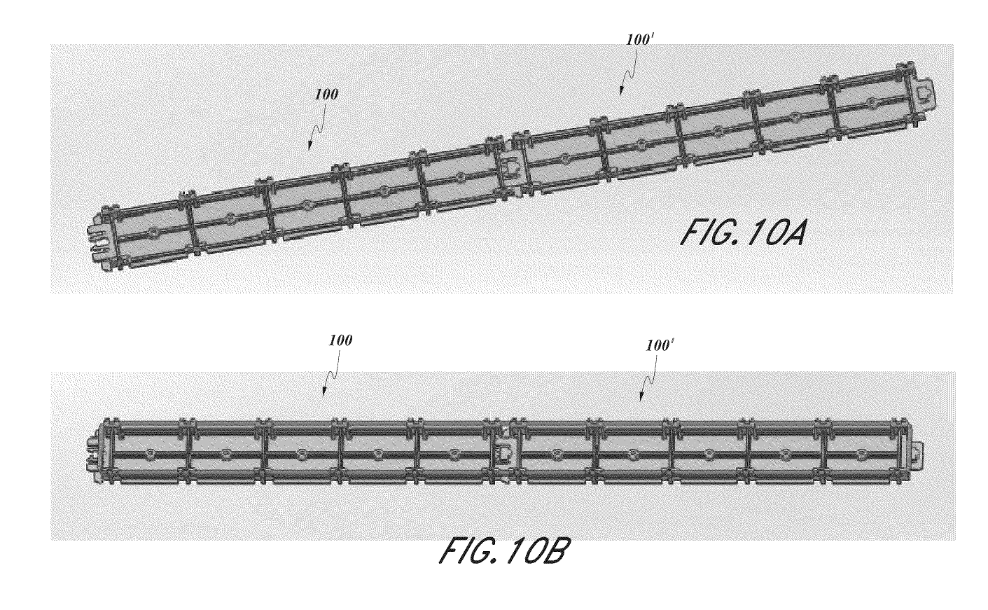

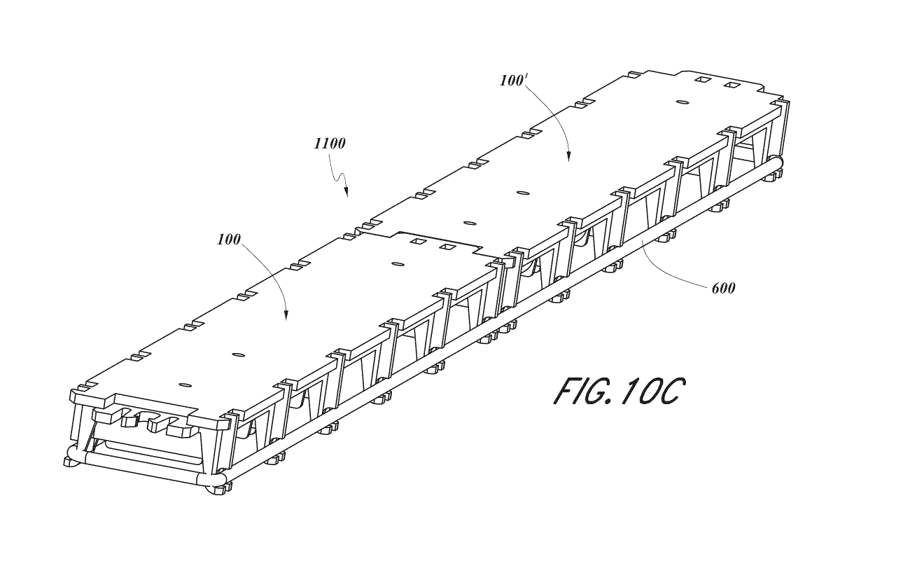

FIGS. 10A-10C illustrate an embodiment of an antenna fixture assembly 1100. As shown, the antenna fixture assembly 1100 can include a plurality (e.g., two) of attached fixtures 100, 100′ and an antenna 600. As is also shown, the antenna 600 can be wrapped around the periphery of the fixtures 100, 100′ and/or secured within the retainers 104 to form a loop antenna. In some embodiments, a generally rectangular loop antenna 600 can be formed. However, other configurations can be used to form different sized and shaped antennas 600. In some embodiments, additional fixtures 100 can be attached to the ends of the shown fixtures 100, 100′ to form even longer antennas. In some embodiments, the attachment mechanisms discussed above can be located on the long sides of the fixtures 100, 100′. Thus, wider loop antennas can also be formed.

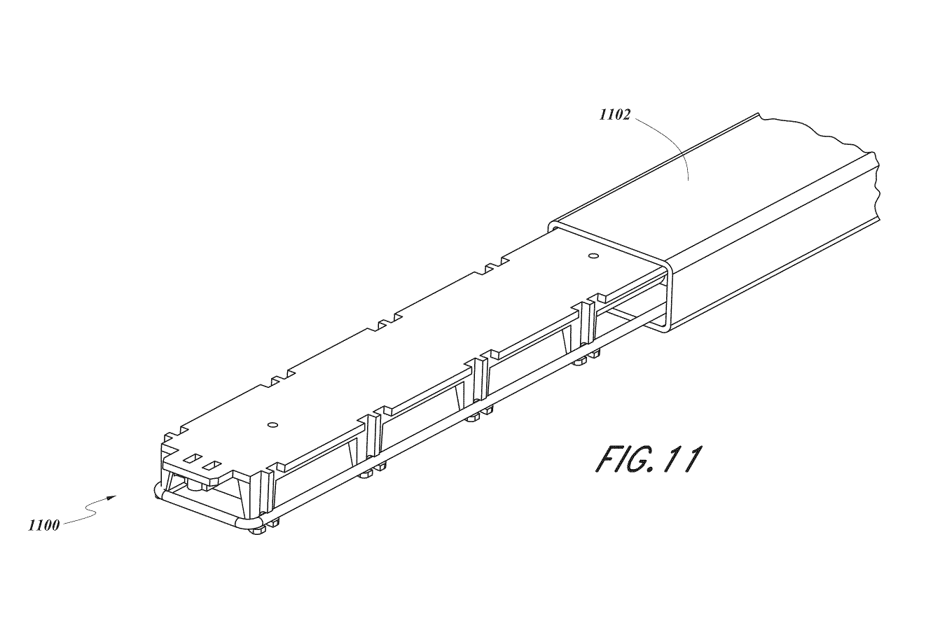

In some embodiments, the antenna fixture assembly 1100 can be inserted into a housing 1102, such as is shown in FIG. 11. The housing 1102 can provide environmental protection to the antenna fixture assembly 1100. The housing 1102 can be sized and configured to accept and retain the antenna fixture assembly 1100. In some embodiments, the housing 1102 can be shaped generally like a rectangular prism. In some embodiments, one end of the housing 1102 can be open. In some embodiments, both ends of the housing 1102 can be open. In some embodiments, the housing 1102 can be made of plastic, metal (e.g., stainless steel or aluminum), or otherwise.

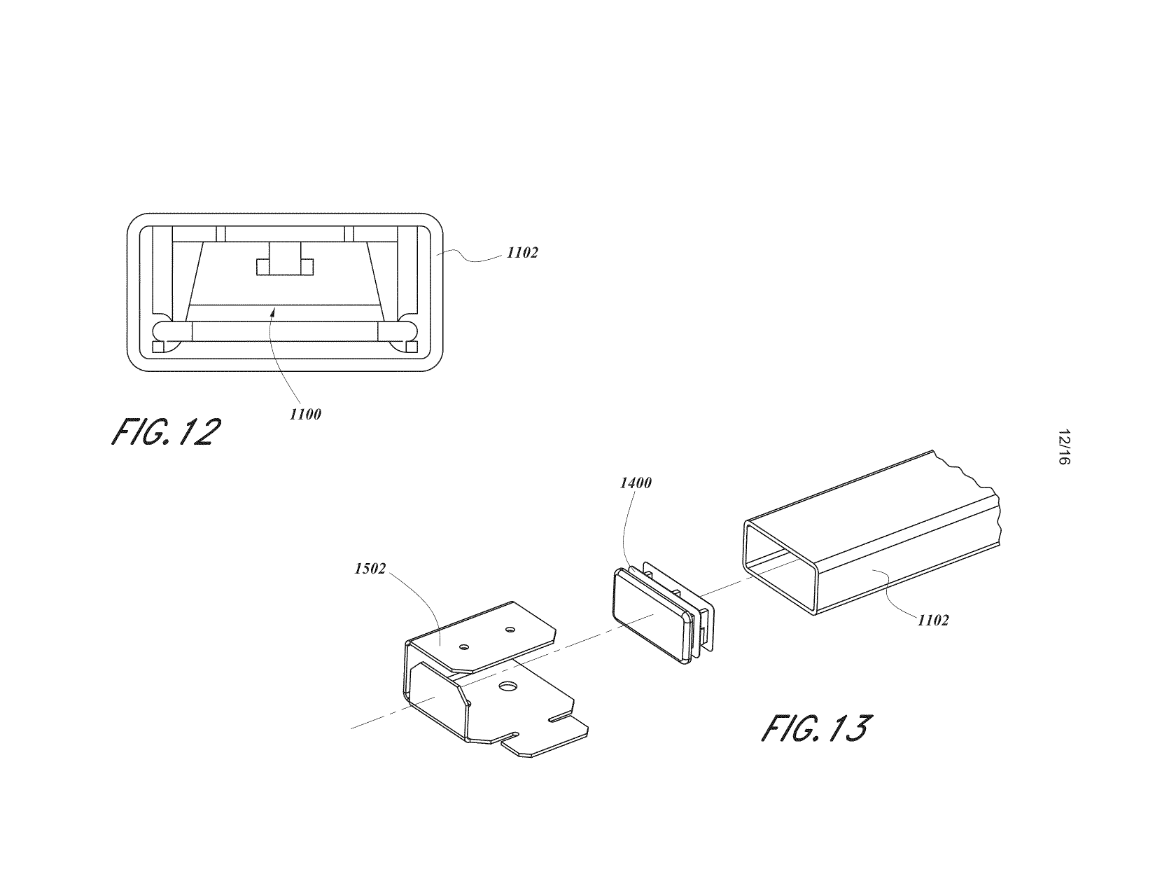

FIG. 12 illustrates the antenna fixture assembly 1100 located within the housing 1102. In some embodiments, the housing 1102 can be sized to inhibit or prevent movement of the antenna fixture assembly 1100 relative to the housing 1102. In some embodiments, the housing 1102 can contain attachment elements, such as screws, which can be used to retain the antenna fixture assembly 1100 in the desired position. In some embodiments, the antenna itself is located in the direction towards the target.

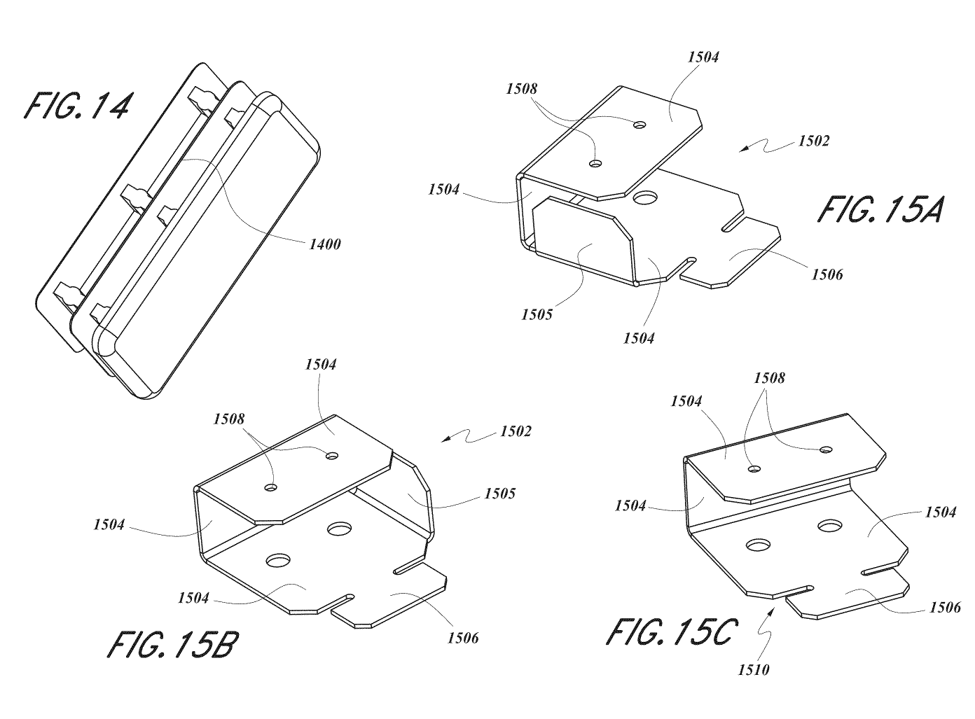

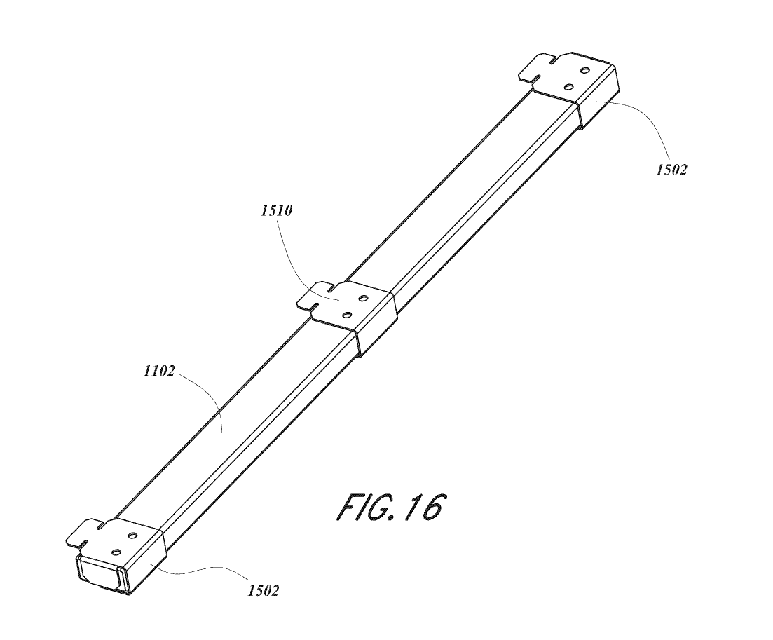

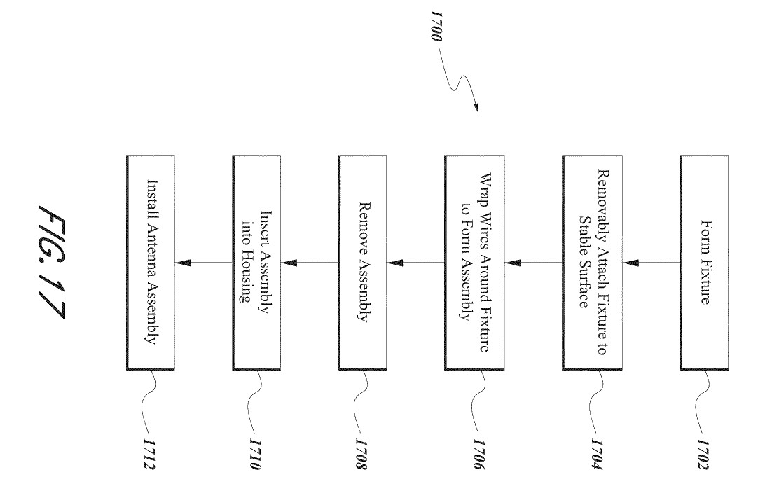

FIG. 13 illustrates end components that can be used with the housing 1102. FIG. 14 and FIGS. 15A-15C show separate viewpoints of the enclosure cap and mounting brackets.

FIG. 14 shows an embodiment of an enclosure cap 1400 that can be used for insertion into the housing 1102. In some embodiments, the enclosure cap 1400 can be sized and shaped to be inserted into the open end of the housing 1102, thus closing off the housing 1102. In some embodiments, the enclosure cap 1400 can surround the open end of the housing 1102. In some embodiments, one or two enclosure caps 1400 can be used to close of the housing 1102, depending on the amount of openings. In some embodiments, the enclosure cap 1400 can be made of a slightly flexible material and be sized slightly greater than the opening in the housing 1102. That way, the enclosure cap 1400 can be compressed for insertion into the housing 1102. Once inserted, the enclosure cap 1400 can then remain in place. In some embodiments, the enclosure cap 1400 can be configured to attach with an antenna fixture assembly 1100 located within the housing 1102.

FIGS. 15A-15C show embodiments of mounting brackets that can be used with the housing 1102. The mounting brackets can be attached to the housing 1102, for example through screws or adhesives though the attachment mechanism is not limiting. The mounting bracket can then be attached to a desired location. In some embodiments, the mounting bracket can be attached to a desired location first, and the housing 1102 can be inserted into the bracket.

FIGS. 15A and 15B show embodiments of the end mounting brackets 1502. As shown, the end mounting brackets 1502 can include walls 1504 to partially surround the housing 1102. In some embodiments, the walls 1504 can partially surround the housing 1102. In some embodiments, the walls 1504 can completely surround the housing 1102. As shown, the end mounting bracket 1502 can include an end wall 1505. This can be used to hold the housing 1102 and enclosure cap 1400 in place. The end mounting bracket 1502 can include a tab 1506. In some embodiments, after the housing 1102 is inserted into the bracket 1502, the tab 1506 can be bent upwards, for example at about a 90° angle, to secure the housing 1102 in place. The tab 1506 can be used as an attachment point to a desired location. In some variants, the end mounting bracket 1502 can include a plurality of apertures 1508. These apertures 1508 can be used for attachment of the mounting bracket 1502 to the housing 1102 using screws.

FIG. 15C shows an embodiment of a middle mounting bracket 1510. As shown, the middle mounting bracket 1510 can be similar or identical to the end mounting bracket 1502. In some variants, the middle mounting bracket 1510 has no end wall 1505.

FIG. 16 shows a full view of an embodiment of a housing 1102 with the mounting brackets 1502, 1510 installed. In some embodiments, multiple middle mounting brackets 1510 can be used, depending on the size and weight of the housing 1102 and antenna fixture assembly 1100.

### Certain Methods of Manufacturing

Various embodiments of the fixtures and fixture assemblies can be used to manufacture antennas, such as loop antennas. In some embodiments, an antenna can be manufactured on the fixture or fixture assembly to form an antenna fixture assembly, and the antenna fixture assembly can be installed at a specific location for use. Therefore, the antenna does not need to be removed from a fixture after manufacturing. Further, as discussed above, multiple fixtures can be attached together to form different shapes, thereby allowing for the formation of antennas having different size. For example, in some embodiments, a single fixture configuration (e.g., size and shape) can be used to form antenna fixture assemblies of various lengths, such as is required to fit a specific doorway.

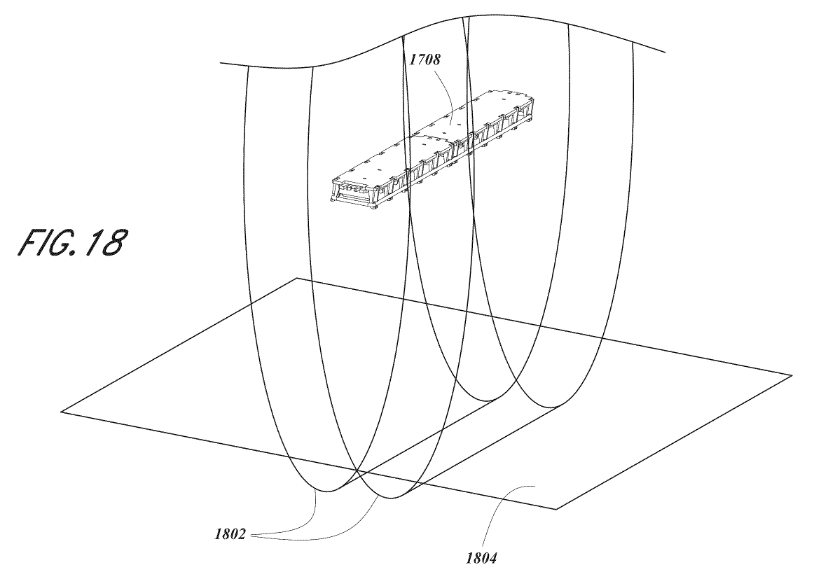

FIG. 17 illustrates an embodiment of a method of manufacturing an antenna fixture assembly. The fixture (or fixture assembly), such as embodiments of those described above, can be formed 1702. This can be done through, for example, injection or compression molding of a plastic.

The fixture can be removably attached to a securing surface 1704, such as a generally flat, stable surface. This attachment can be through the use of, for example, screws that can connect to apertures 206 of the fixtures.

Antenna wires can be wrapped around the fixture 1706 to form the antenna fixture assembly. For example, the wires can be wrapped around the fixtures and retained in the retainers 104 as discussed above. The wires can be wrapped around the fixture to form bundles, which together can make a loop antenna.

The antenna fixture assembly can be removed 1708 from the securing surface. Accordingly, both the antenna and fixture are completely removed. The antenna does not have to be removed from the fixture. This can reduce or eliminate the chance of damaging the antenna, such as damage that could otherwise occur were the antenna to be removed from the fixture. Some embodiments of the disclosed process can be advantageous as removal of the antenna from the fixture can affect certain signal properties, such as field strength and/or positioning. By maintaining the antenna on the fixture, improved and/or optimized properties can be achieved.

As shown, the assembly can optionally be inserted into a housing 1710. The housing and installation are discussed in detail above. However, in some embodiments, the assembly 1708 can be installed without a housing.

The antenna fixture assembly, whether in the housing or not, can be installed 1712. Accordingly, in some embodiments, the antenna can be maintained on the fixture, and the fixture is mounted in a desired location, such as in an upper portion of a door (e.g., between the jambs). Thus, the antenna can be both formed and installed without being removed from the fixture.

Accordingly, the assembly can be shipped and attached as a single unit, and an end user is not required to assemble the antenna and/or the fixture. Rather, the installer can proceed directly to hanging the assembly in the desired location. In some embodiments, the assembly can be shipped already in the housing. This alleviates the hassle of putting the different structures together prior to attachment at a location.

### Certain Methods of Use

In some embodiments, the antenna assembly 1708 can be configured to provide a field 1802 of a certain size and/or shape on a plane. For example, as shown in FIG. 18, the field 1802 produced by the loop antenna can be configured to provide a field that interfaces with a floor plane 1804. In some embodiments, the field 1802 can have a generally toroidal shape. However, the specific shape of the field 1802 is not limiting as the loop antenna can be formed in any desired configuration.

In various embodiments, where the field lines of the field 1802 pass through the floor plane 1804, a signaling zone can be defined. The shape of the signaling zone can be controlled by adjusting the size (e.g., width) of the antenna loop, such as through the manufacturing steps described above using more or less fixtures, and the signal strength. Because the fixture defines the size of the antenna, adjusting the size of the fixture can allow the size of the field and/or of the signaling zone to be adjusted. For example, the fixture can be adjusted such that the signaling zone is about the same width as a desired door.

In some embodiments, the antenna can be sized to provide a field that interfaces with the floor plane at an entrance door and/or exit door of a retail store. Accordingly, in some embodiments, the signal from the loop antenna can instruct receiving devices (e.g., transceivers on hand-held baskets and/or on shopping carts) to activate an alarm if the loop antenna signal is received. For example, when a transceiver on a shopping cart (e.g., in a wheel of the cart) enters the signaling zone, then the cart wheel can be locked, thereby inhibiting the cart from exiting the store. In some variants, the cart will not lock if it has received a permission command to exit the store.

In various embodiments, where the field lines pass through the floor plane, a signaling zone can be defined. The shape of the signaling zone can be controlled by adjusting the size (e.g., width) of the antenna loop and the signal strength. Because the fixture defines the size of the antenna, adjusting the size of the fixture can allow the size of the field and/or of the signaling zone to be adjusted. For example, the fixture can be adjusted such that the signaling zone is about the same width as a desired door.

In some embodiments, the signal from the loop antenna can instruct receiving devices (e.g., transceivers on hand-held baskets and/or on shopping carts) to activate an alarm if the loop antenna signal is received. For example, when a transceiver on a shopping cart (e.g., in a wheel of the cart) enters the signaling zone, then the cart wheel can be locked, thereby inhibiting the cart from exiting the store. In some variants, the cart will not lock if it has received a permission command to exit the store.

In some embodiments, it can be advantageous for the signaling zone to have a reduced size. This can aid in avoiding unintentional activations of the transceivers, such as when a cart travels close to the door, but is not attempting to pass through the door. In some embodiments, the signaling zone has a generally long and narrow rectangular shape. For example, in some implementations, the ratio of the length of the signaling zone to the width of the signaling zone is at least about: 3:1, 5:1, 7:1, 10:1, 15:1, values between the aforementioned values, or otherwise. However, the size of the signaling zone is not limiting, and can be adjusted by changes in the size of the fixture. In some embodiments, in which the fixture is mounted on or near a door, the signaling zone is about as long as the door is wide or, in the case of a double door, as long as both the doors combined are wide.

### Certain Terminology

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes, or tends toward, a particular value, amount, or characteristic.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### Summary

Although this disclosure describes certain embodiments and examples of fixtures, fixture assemblies, and antenna fixture assemblies, many aspects of the methods and devices shown and described in the present disclosure may be combined differently and/or modified to form still further embodiments or acceptable examples. All such modifications and variations are intended to be included herein within the scope of this disclosure. Indeed, a wide variety of designs and approaches are possible and are within the scope of this disclosure. While illustrative embodiments have been described herein, the scope of any and all embodiments having equivalent elements, modifications, omissions, combinations (e.g., of aspects across various embodiments), adaptations and/or alterations as would be appreciated by those in the art based on the present disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of antenna fixtures and methods have been disclosed. Although the antenna fixtures and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

The following is claimed:

1. A removable antenna fixture assembly for assembly of an antenna, the antenna fixture comprising:
an antenna fixture comprising:
a platform having a first end and a second end, the first and second end located generally opposite from one another;
a plurality of legs extending around the periphery of the platform, each of the plurality of legs having an antenna retainer portion; and
a first attachment element, the first attachment element located on the first end of the platform and having a first attachment configuration;
a wire wrapped around the plurality of legs and retained within the antenna retainer portion of the plurality of legs, the wrapped wire thereby forming a loop antenna; and
wherein the first attachment element of the antenna fixture is configured to mate with a second attachment element of a second antenna fixture, such that the antenna fixture is secured with the second antenna fixture.

2. The removable antenna fixture assembly of claim 1, wherein the platform comprises a threaded aperture passing at least partially through a thickness of the platform, the threaded aperture configured to receive and retain a screw for removable attachment of the platform to a surface.

3. The removable antenna fixture assembly of claim 1, wherein the platform comprises a score line configured to reduce the size of the removable fixture upon breaking.

4. The removable antenna fixture assembly of claim 1, wherein the removable antenna fixture comprises a plurality of pairs of legs, the legs in each pair being located on opposite side of a width of the platform from one another.

5. The removable antenna fixture assembly of claim 4, further comprising cross support structures connecting the pairs of legs.

6. The removable antenna fixture assembly of claim 5, further comprising axial support structures connecting adjacent cross support structures.

7. The removable antenna fixture assembly of claim 1, further comprising an energy source and transmitter attached to the platform.

8. The removable antenna fixture assembly of claim 1, further comprising the second antenna fixture.

9. The removable antenna fixture assembly of claim 8, wherein the antenna fixture and the second antenna fixture are identical.

10. The removable antenna fixture assembly of claim 8, further comprising a housing configured to slidably receive the fixtures.

11. A method of manufacturing a loop antenna, the method comprising:
obtaining a fixture comprising:
a platform having a first end and a second end, the first and second ends being located generally opposite of one another; and
a plurality of retainers positioned around a periphery of the platform;
securing the fixture to a base;
wrapping a wire around the retainers of the fixture to form a loop, the loop and fixture together comprising an antenna assembly; and
removing the fixture from the base without removing the loop from the retainers of the fixture.

12. The method of Clam 11, wherein the fixture is a first fixture and further comprising providing a second fixture comprising:
a platform having a first end and a second end, the first and second ends being located generally opposite of one another; and
a plurality of retainers positioned around a periphery of the platform of the second fixture; and
attaching the second fixture to the first fixture.

13. The method of Clam 12, wherein the first and second fixtures are attached prior to securing the first fixture to the base.

14. The method of Clam 12, wherein the first fixture is secured to the base before attaching the first and second fixtures.

15. The method of Clam 12, further comprising wrapping a second wire around the second fixture.

16. The method of Clam 12, wherein wrapping the wire around the retainers comprising wrapping the wire around the retainers of both the first and second fixtures to form one loop encompassing both the first and second fixtures.

17. The method of Clam 11, further comprising installing the antenna assembly.

18. The method of claim 17, wherein the antenna assembly is configured to be installed in an overhead location.

19. The method of claim 17, further comprising connecting a transmitter located on the fixture, thereby facilitating the transmission of a signal from the transmitter via the antenna assembly to produce a signal zone on a floor region below the overhead location.

20. An antenna fixture assembly comprising:
a first antenna fixture comprising:
a first platform having a first end and a second end, the first and second end located generally opposite from one another;
a first plurality of legs each comprising an antenna retainer portion; and
a first male connection element located on the first end of the first platform;
a first female connection element located on the second end of the first platform;
a second antenna fixture comprising:
a second platform having a first end and a second end, the first and second end located generally opposite from one another;
a second plurality of legs each comprising an antenna retainer portion;
a second male connection element located on the first end of the second platform;
a second female connection element located on the second end of the second platform;
wherein the first male connection element located on the first end of the first platform is matingly engaged with the second female connection element located on the second end of the second platform, thereby forming a linked assembly of the first and second antenna fixtures;
a conducting element wrapped around the periphery of the linked assembly of the first and second antenna fixtures, the conducting element being received in the antenna retainer portions the plurality of legs, the conducting element thereby forming a loop antenna that is secured with and supported by the first and second antenna fixtures.
